(19) United States
(12) Patent Application Publication
(10) Pub. No.: US 2014/0181854 A1
(43) Pub. Date: Jun. 26, 2014

(54) SYSTEM AND A METHOD FOR INTERPRETATING DATA VIA AUDIENCE POLLING SYSTEM

(71) Applicant: Shmuel Finkelstein, Lafayette, CA (US)

(72) Inventors: Shmuel Finkelstein, Lafayette, CA (US); Ryan Sharon, San Francisco, CA (US)

(73) Assignee: Shmuel Finkelstein, Lafayette, CA (US)

(21) Appl. No.: 14/140,890

(22) Filed: Dec. 26, 2013

Related U.S. Application Data
(60) Provisional application No. 61/745,910, filed on Dec. 26, 2012.

(51) Int. Cl. H04N 21/475

(52) U.S. Cl. CPC H04N 21/4758
USPC 725/24

(57) ABSTRACT

A method and a system for interpreting data of audience from a polling session is provided in the present invention. The moderator creates a session for conducting a polling session. The moderator further generates a static data of audience from their personal details obtained from the social networking accounts and a dynamic data from a session moderator survey for obtaining the information not available publically. The data from the static survey and dynamic survey is interpreted to obtain a filtered data of population using specific variables giving the moderator the ability to compartmentalize the collected sample data. This collected sample data is available for analytical interpretation and further helps in generated reports for specific population.

### CROSS-REFERENCE TO RELATED APPLICATION

This application claims priority to a U.S. Provisional Application No. 61/745,910 filed on Dec. 26, 2012, the entire contents of which are incorporated herein by references in its entirety.

### BACKGROUND OF THE INVENTION

1. Field of the Invention

The present invention generally relates to an audience polling system and more particularly relates to a system and a method for interpreting data from the audience polling system.

2. Description of Related Art

A polling system is a part of an audience response system. Audience response system provides a platform to create an interaction between a presenter and their audience. Previously, audience response systems are conducted in a common room such as classroom, corporate conference rooms and/or in other similar gatherings. Here the audience respond to the questions asked by the presenter and provide their feedback either on paper or through their phones.

In the cases when the audiences are not located at same location, the presenter presents the questions to the audience via internet on their personal computers. The audience responds either through their personal computer or through the mobile. Here, the audience needs to install the software which allows answering to the questions asked by the presenter.

Such polls are conducted to obtain variety of information. For exemplary purposes, the information could be either to obtain information on various goods, services, voting for candidate, status of economy, and the like. A large number of people participate in such audience and a lot of data about the audience views on a particular topic is obtained. Various existing software systems are focusing on general polling and thus creates a need of a method and a system for interpreting data of audience from a polling session. Further, the method and the system should conduct a survey to obtain various static and dynamic data of the audience and generates reports on the selected data of the audience.

### SUMMARY OF THE INVENTION

In accordance with the teachings of the present invention, a method and a system for interpreting data of audience from polling session is provided.

An object of the present invention is to provide a method for interpreting data of audience from a polling session. The method includes step of registration of the moderator and then allowing the moderator to create questions and their answers in a session moderator module. Further, the method includes the step of registering the audience computing device for the polling session and to generate static data related to the audience and conducting a session moderator survey of the registered audience for generating a dynamic data related to the audience.

Further, the method includes the step of presenting the questions to the audience and then allowing the audience to answer to questions from their computing devices in real time. Further, the method includes the step of interpreting the static data with the dynamic data of session moderator survey to filter the audience participating in the polling session for generating reports and then downloading the reports.

Another object of the present invention is to provide a method including a step of scanning a code by the audience from their computing device for participating in the polling session.

Another object of the present invention is to provide a method including a step of manipulating the questions created in the session moderator module.

Another object of the present invention is to provide a method including a step of setting a time for allowing the audience to answer each question displayed during the polling session.

Another object of the present invention is to provide a method including a step of setting the type of each question to be asked from the audience through a question type module.

Another object of the present invention is to provide a method including a step of setting the number of answers for each question to be asked from the audience through an answer module.

Another object of the present invention is to provide a system including a database and processor. The database stores information related to audience, moderator and polling session and the processor executes the steps provided under the method for interpreting data of audience from a polling session managed by a moderator.

Another object of the present invention is to provide a non-transitory computer readable storage medium having instructions for a database stored and executed by a processing device, causing the processing device to perform the method for interpreting data of audience from a polling session managed by a moderator over a communication network.

Further features and advantages of the present invention, as well as the structure and operation of various embodiments of the present invention, are described in detail below with reference to the accompanying drawings.

### BRIEF DESCRIPTION OF DRAWINGS

FIG. 1 illustrates a flowchart of a method for interpreting data of audience from a polling session managed by a moderator, in accordance with a preferred embodiment of the present invention;

FIG. 2 illustrates a system for interpreting data of audience from a polling session managed by a moderator, in accordance with a preferred embodiment of the present invention;

FIG. 3 is a screenshot showing, by way of an example, a Web page for a registration module for moderator;

FIG. 4a is a screenshot showing, by way of an example, a Web page for creating questions through session moderator module;

FIG. 4b is a screenshot showing, by way of an example, a Web page for displaying list of questions in the session moderator module;

FIG. 5 is a screenshot showing, by way of an example, a Web page for registration of audience computing device for generating static data related to the audience under session moderator module;

FIG. 6 is a screenshot showing, by way of an example, a Web page for conducting a session moderator survey of the registered audience for generating dynamic data under session moderator module;

FIG. 7 is a screenshot showing, by way of an example, a Web page for presenting the questions to the audience through the prompter module;

FIG. 8 is a screenshot showing, by way of an example, a Web page of audience communication device for responding to the questions;

FIG. 9 is a block diagram for showing interpretation of data from the analysis of static survey and dynamic survey;

FIG. 10 is a screenshot showing, by way of an example, a Web page for presenting the reports of answers provided by the audience;

FIG. 11 is a screenshot showing, by way of an example, a Web page of audience communication device showing scanning of QR code;

FIG. 12 is a screenshot showing, by way of an example, a Web page for showing manipulation of session moderator module; and

FIG. 13 is a screenshot showing, by way of an example, a Web page of audience computing device to show the voting status of audience.

### DETAILED DESCRIPTION OF THE INVENTION

While this technology is illustrated and described in a preferred embodiment, a system and method for interpreting data of audience from a polling session managed by a moderator may be produced and described in many different configurations, forms and various methods, without deviating from the scope of present invention. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

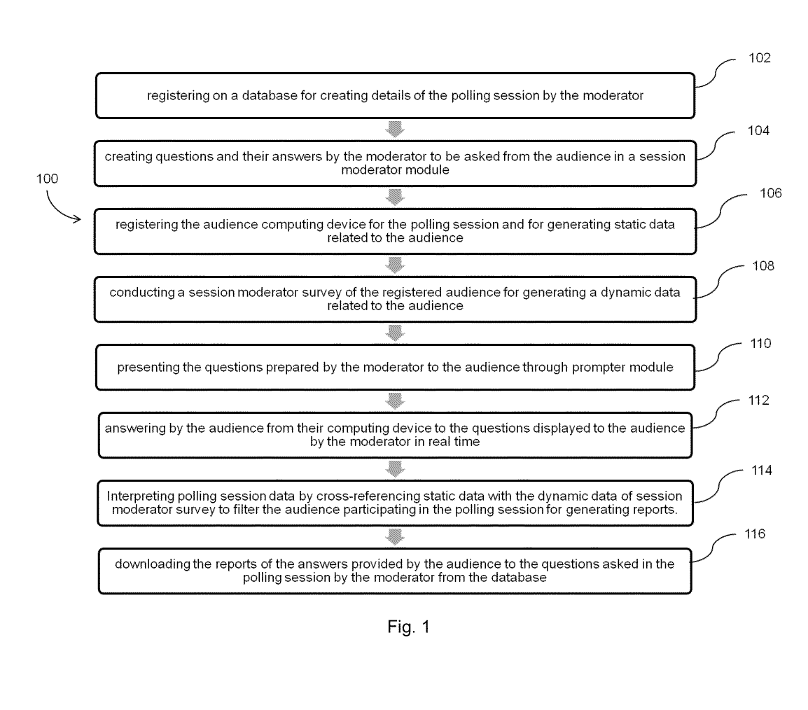

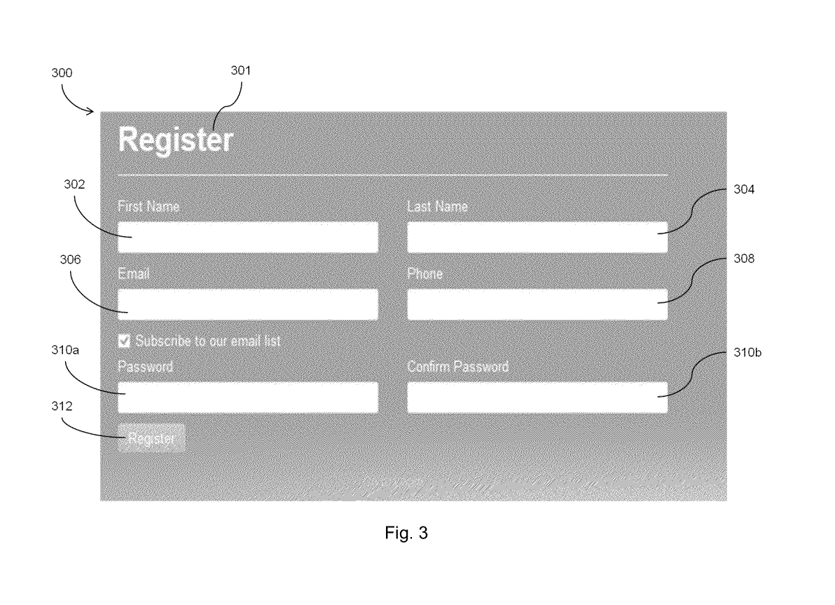

FIG. 1 illustrates a flowchart of a method 100 for interpreting data of audience from a polling session managed by a moderator. The method 100 initiates with a step 102 for registering on a database for creating details of the polling session by the moderator by a moderator computing device via registration module. The registration of a moderator is explained in detailed in conjunction with FIG. 3 of the present invention.

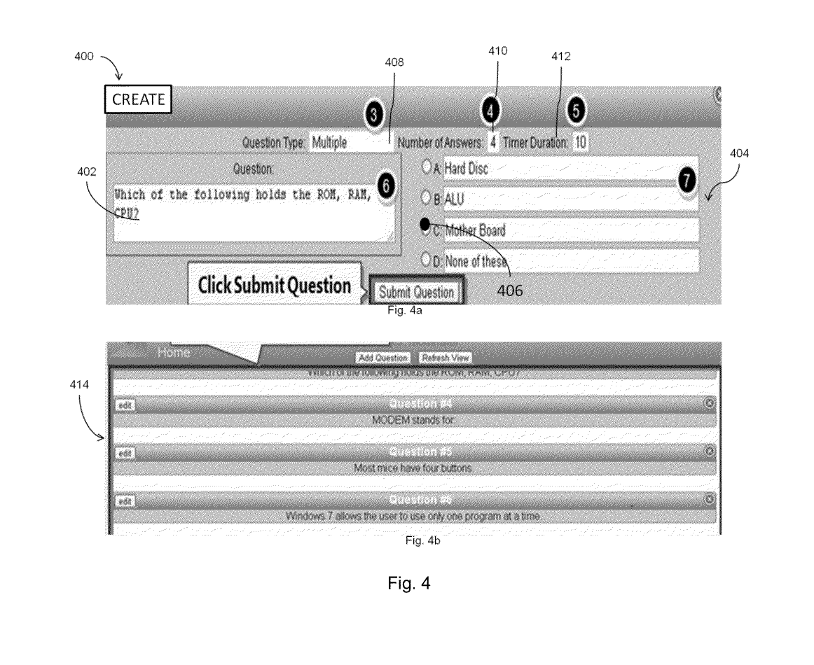

The step 102 is then followed by a step 104 for creating questions and their answers by the moderator to be asked from the audience in a session moderator module. In a preferred embodiment of the present invention, the moderator is free to create any type and any number of questions for the audience in the session moderator module. The creation of questions in the session moderator module is explained in detail in conjunction with FIG. 4 of the present invention.

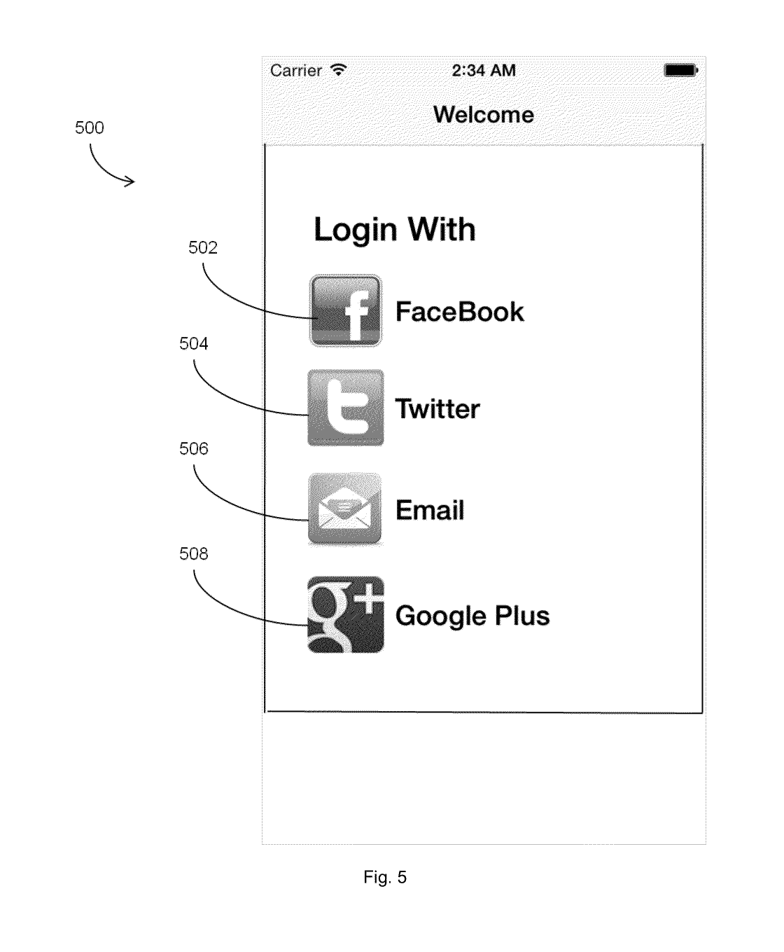

The step 104 is then followed by a step 106 for registering the audience computing device for the polling session and for generating static data related to the audience. In a preferred embodiment of the present invention, the static data of the audience are the details obtained from their social networking profiles. The registration of the audience device and the static data of audience is explained in detailed in conjunction with FIG. 5 of the present invention.

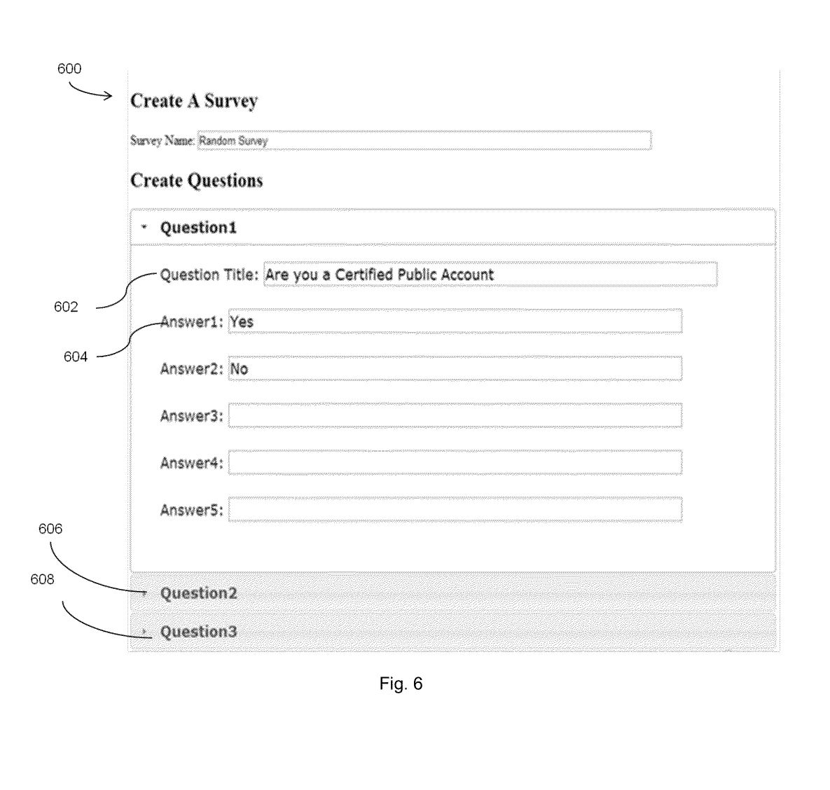

The step 106 is then followed by a step 108 for conducting a session moderator survey of the registered audience for generating a dynamic data related to the audience. The session moderator survey is conducted to obtain data dynamic data related to the audience. The dynamic data varies according to the requirements of the moderator. An example of session moderator survey for generating dynamic data is explained in detail in conjunction with FIG. 6 of the present invention.

The step 108 is then followed by a step 110 for presenting the questions prepared by the moderator to the audience through the prompter module. The prompter module allows the database to connect with a display screen and the questions are displayed on the display screen. In a preferred embodiment of the present invention, the display screen is located at common location where the polling session is taking place.

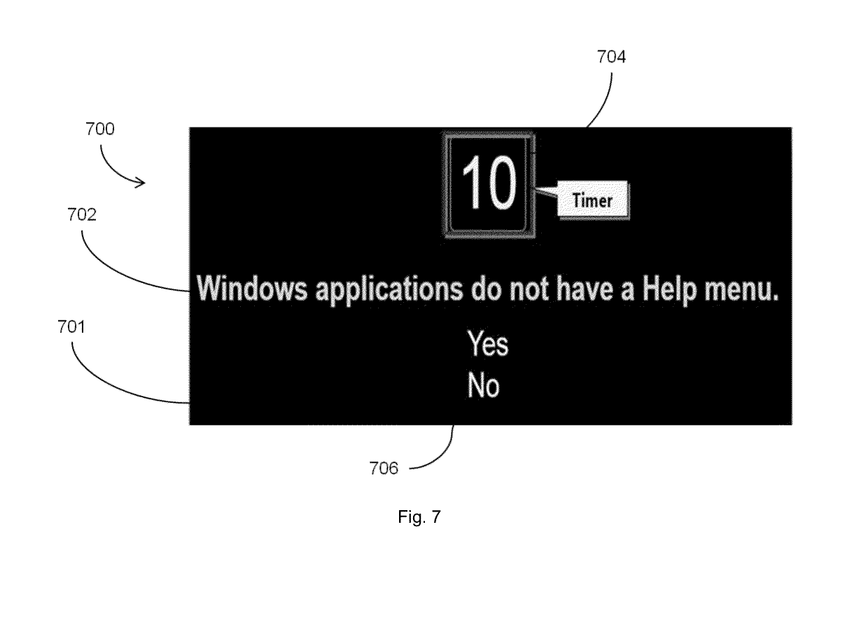

For exemplary purposes, the display screen is a projector and which is visible to the audience. In another embodiment of the present invention, the display screen is the display screen of audience computing device. Examples of computing device includes but not limited to a tablet, a personal computer, laptop, mobile, notebook etc. An example of the presentation of the questions on the displays screen is shown in FIG. 7 of the present invention.

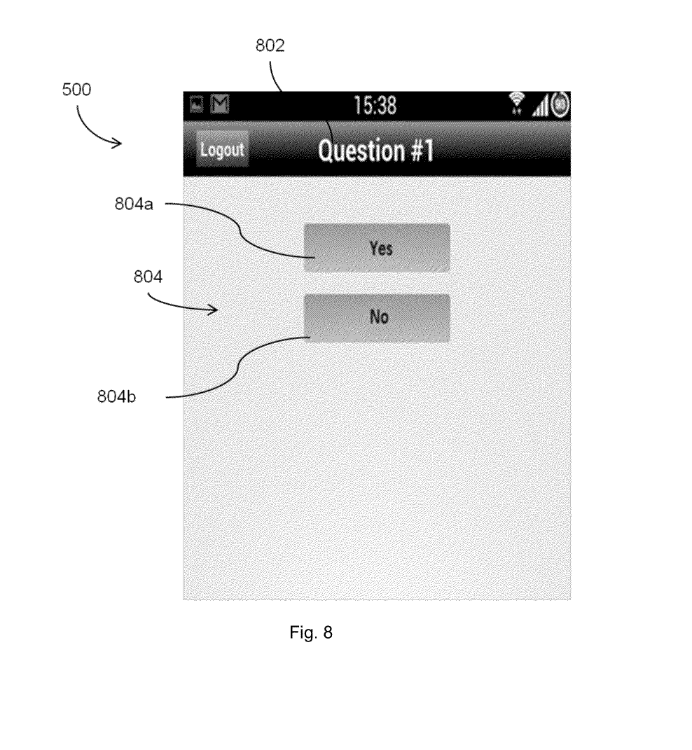

The step 110 is then followed by a step 112 for answering by the audience from their computing device to the questions displayed to the audience by the moderator in real time. Example of audience computing device includes but not limited to computer, Ipad, phones, notebooks and laptop. Example of replying of answers to the questions asked from the audience is explained in detail in conjunction with FIG. 8 of the present invention.

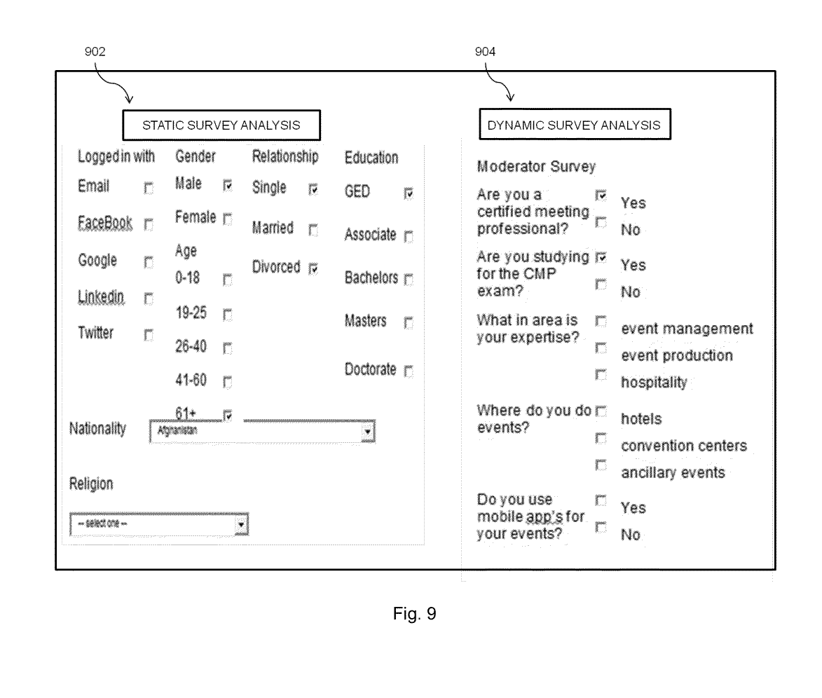

The step 112 is then followed by a step 114 of interpreting polling session data by cross-referencing the static data with the dynamic data to filter the audience participating in the polling session for generating reports. In a preferred embodiment of the present invention, the audience is filtered into various categories depending upon the requirement of the polling session data. Further, reports are generated specifically for the filtered data. The interpretation of polling session data is explained in detail in conjunction with FIG. 9 of the present invention.

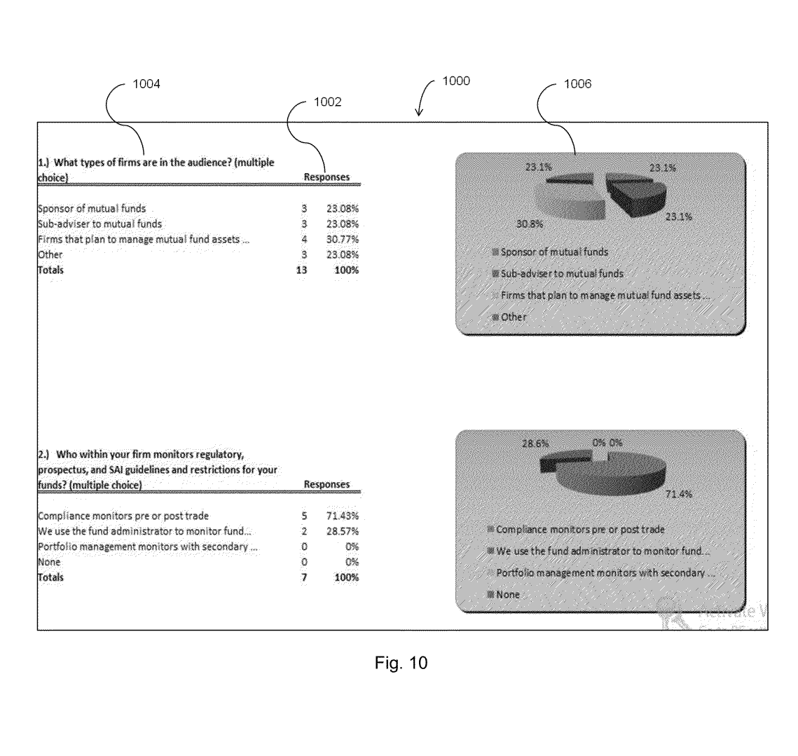

The step 114 is then followed by a step 116 of downloading the reports of the answers provided by the audience to the questions asked in the polling session by the moderator from the database. In a preferred embodiment of the present invention, the reports are saved in the database and thus could be downloaded whenever they are required. An example of the format of report is shown and explained in FIG. 10 of the present invention.

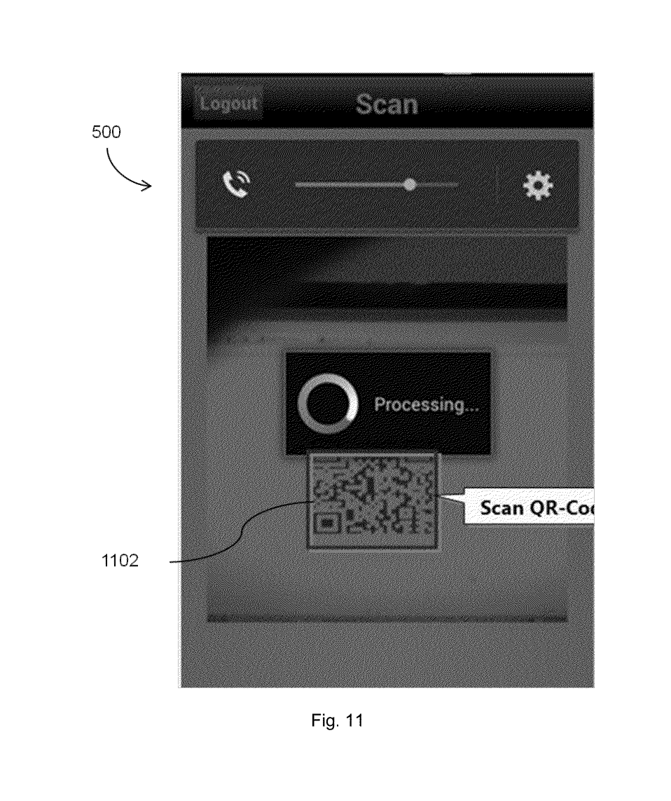

In another preferred embodiment of the present invention, the method 100 includes a step of scanning a code by the audience from their computing device for participating in the polling session. Example of code includes but not limited to QR code. The scanning of code by the audience computing device is shown and explained in detail in conjunction with FIG. 11 of the present invention.

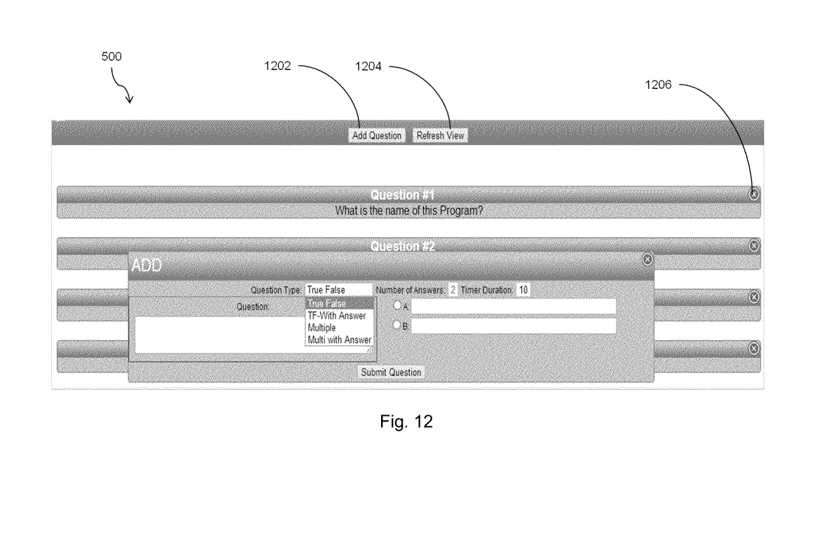

In another preferred embodiment of the present invention, the method 100 includes a step of manipulating the questions created in the session moderator module. The manipulation includes but not limited to addition of questions, deletion of questions, and refreshing of the questions. The manipulation of the questions is explained in detailed in conjunction with FIG. 12 of the present invention.

In another preferred embodiment of the present invention, the method 100 includes a step of setting a time for allowing the audience to answer each question displayed during the polling session. The time here refers to the duration given to the audience for replying to the question. An example of time duration is explained in detail in conjunction with FIG. 12 of the present invention.

In another preferred embodiment of the present invention, the method 100 includes a step of setting the type of question to be asked from the audience through a question type module. In a preferred embodiment of the present invention, the question type module includes various types of questions format that moderator can select to ask questions from the audience. An example of the question type module is explained in detailed in conjunction with FIG. 12 of the present invention.

In another preferred embodiment of the present invention, the method 100 includes a step of setting the number of answers for each question to be asked from the audience through an answer module. In a preferred embodiment of the present invention, the moderator selects the number of answers for each question so that the audience has the option to select or provide the answer. An example of the answer module is explained in detail in conjunction with FIG. 12 of the present invention.

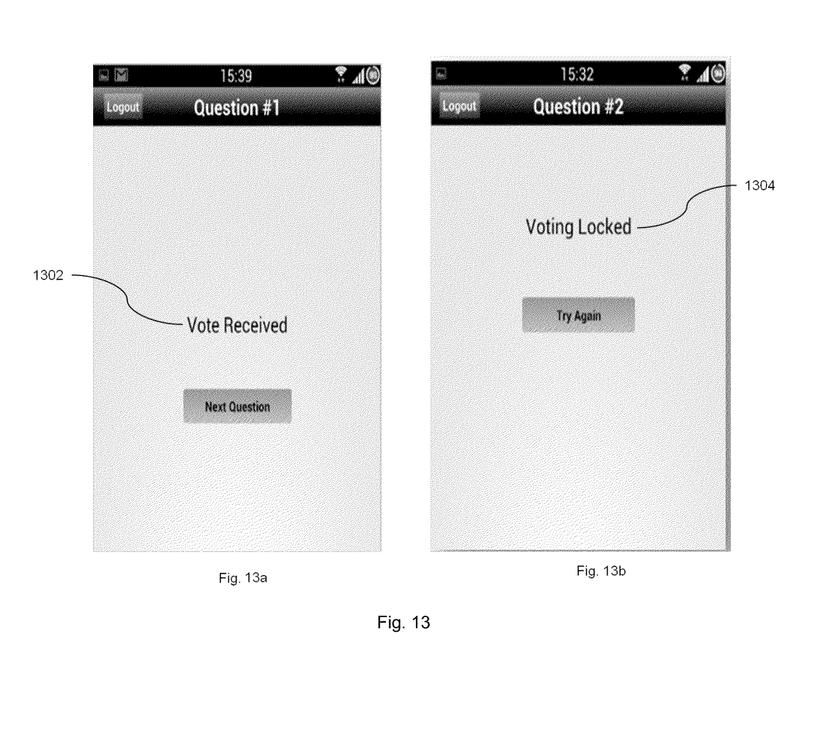

In another embodiment of the present invention, the method 100 includes a step of sending a notification on the audience computing device after each question about the status of their voting. In a preferred embodiment of the present invention, the voting here refers to the answers provided by the audience to questions displayed on the audience computing device. An example of notification received on the audience computing device is explained in detail in conjunction with FIG. 13 of the present invention.

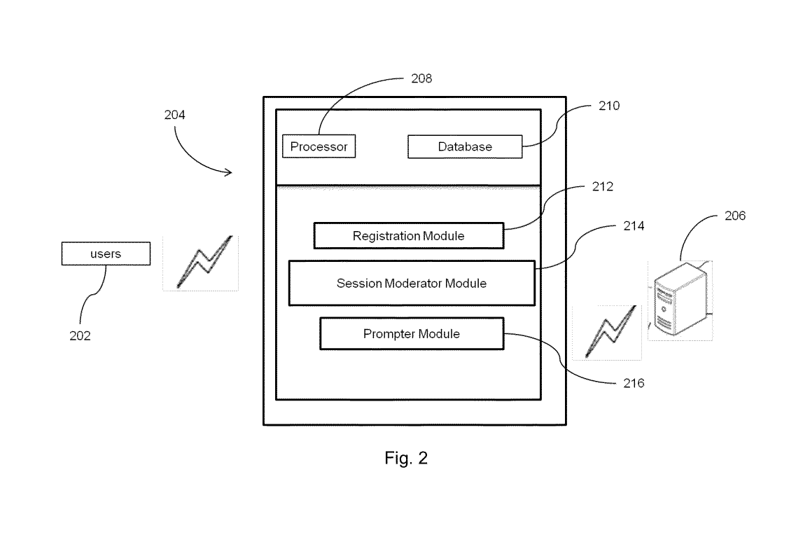

FIG. 2 is a schematic overview of the components a network environment 200. The network 200 includes users 202, a system 204 and a server 206. The system 204 for interpreting data of audience from a polling session managed by a moderator over a server is operated by the users 202 and communicates through the server 206. The system 204 includes a processing device 208 and a database 210. The users 202 are moderator and audience of the polling session.

The database 210 includes storing data related to audience, moderator and the polling session and the processor 208 is coupled to the database 210. The processor 208 is configured to process a registration module 212, session moderator module 214 and prompter module 216. The registration module 212, the session moderator module 214 and the prompter module 216 is explained in detail in conjunction with FIG. 1, FIG. 3, FIG. 4 and FIG. 7 respectively.

FIG. 3 is a screenshot showing, by way of an example, a Web page of a moderator computing device 300 having a registration module 301 for a moderator. The registration module 301 allows the moderator to provide credentials for creating an account in the database. In an exemplary embodiment of the present invention, the registration module 300 includes First Name 302, Last Name 304, Email 306, Phone No. 308, Password 310a, Confirm Password 310b and Register 312.

In the First Name 302 and the Last Name 304, the moderator provides the complete name to the database. Further in the Email 306, Phone 308 Password 310a and Confirm Password 310b the moderator provides a valid Email address and then provides a password and confirms the password that the moderator would like to use to operate the session moderator module and prompter module. In a preferred embodiment of the present invention, the Phone 308 is required to send notifications in case of forget password. The register 312 allows the moderator to register on the database.

FIG. 4 is a screenshot showing, by way of an example, a Web page for creating questions through session moderator module 400. In a preferred embodiment of the present invention, the session moderator module 400 allows the moderator to create questions that they need to ask from the audience in the polling session. In an exemplary embodiment of the present invention, the session moderator module 400 includes a Type Section 402 for allowing the moderator to type the question and an Answer Section 404 to allow the moderator to provide one or more answers with at least one correct answer to the question. For exemplary purposes, the answer section 404 shows four options of answering to the question displayed in the Answer Section 404. The correct answer is provided by highlighting the right answer from one or more answers. For example, answer ‘C’ 406 is marked as the correct answer to the question asked in the Type Section 402.

The session moderator module 400 further includes a Question Type Module 408 for selecting the type of question to be asked from the audience, Number of Answer Module 410 for providing the answer options to each question asked and time duration module 412 allows the moderator to set a time for allowing the audience to answer each question displayed during the polling session. For exemplary purposes, the Question Type Module 408 is ‘Multiple’, Number of Answers module is ‘4’ and time duration module 412 is ‘10 seconds’. The Question Type Module 408, Number of Answer Module 410 and the Time Duration Module 412 are explained in detailed in conjunction with FIG. 13 of the present invention.

FIG. 4b is a screenshot showing, by way of an example, a Web page for displaying list 414 of questions in the session moderator module 400. For exemplary purposes, the list 414 displayed contains six questions. However, the moderator may add n number of questions that they would like to ask from the audience.

FIG. 5 is a screenshot showing, by way of an example, a Web page for registration of audience computing device 500 for generating static data related to the audience under session moderator module. The audience computing device 500 is presented with the various social network login options such as Facebook 502, Twitter 504, Email 506 and Google Plus 508. However, it will be readily apparent to those skilled in the art that various other social network login options may also be envisioned without deviating from the scope of the invention.

For exemplary purposes, the audience selects Facebook 502 for registering on the database. The static data of the audience is extracted from the Facebook 502 account of the audience. Herein static data relates to the personal information of the audience such as name, age, gender, email ID, number of friends/connects, address, religion, relationship status etc. However, it will be readily apparent to those skilled in the art that other personal information may also be envisioned without deviating from the scope of the invention.

FIG. 6 is a screenshot showing, by way of an example, a Web page for conducting a session moderator survey 600 of the registered audience for generating dynamic data under session moderator module. The dynamic data under the session moderator survey 600 is evaluated from the details of the audience that are not available on the social networking sites.

For exemplary purposes as shown in FIG. 6, the moderator can set any number of questions in the survey 600. Question 1 having a Question Title 602 ‘Are you a Certified Public Account’ and for each question there could be multiple options such as Answer 1 Yes 602 and Answer 2 No 604. However, it will be readily apparent to those skilled in the art that various other details may also be extracted from the session moderator survey 600 without deviating from the scope of the invention. The user can select the answer for each question from each survey 600. Similarly, the moderator can ask other questions from the audience such as ‘Question 2’ 606 and ‘Question 3’ 608.

FIG. 7 is a screenshot showing, by way of an example, a Web page for presenting the questions to the audience through the prompter module 700. The prompter module 700 provides a prompter screen 701 to display the list of questions created under session moderator module. The prompter screen 701 is connected to the session moderator module. The examples of prompter screen 701 include but not limited to projector, display screen of computer, laptop, IPAD, notebook etc. The prompter screen 701 includes wireless connecting devices such as Bluetooth, Infrared, internet and Wireless Modem etc to connect with the moderator computing device.

For exemplary purposes, the question 702 displayed on the prompter screen 701 is ‘Windows applications do not have a Help Menu’. The prompter module further includes a timer 704 to display the time left for answering the question and answering options 706 shows one or more answering options to the audience for selecting an option to answer from the audience computing device. In a preferred embodiment of the present invention, the moderator operates the session moderator module and further displays the question on the prompter screen 700 one by one for the audience to respond on them. The audience is allowed to respond within the time duration given to them.

FIG. 8 is a screenshot showing, by way of an example, a Webpage of audience computing device 500 for responding to the questions. After registration of the audience computing device 500 on the database, the question number 802 provides the question number of the polling session and one or more answering options 804 such as 804a and 804b for allowing the audience to select an option to answer to the question displayed on the prompter screen.

In case of touch screen computing device, the audience can select the answer by stylus, fingers etc and in case of non-touch screen computing device a mouse may be used to select the an option from one or more answering options 804. For exemplary purposes as shown in FIG. 8, the question number 802 is ‘1’ and the one or more answering options 804 is ‘Yes’ or ‘No’.

FIG. 9 is a block diagram for showing interpretation of data from the analysis of static survey 902 and dynamic survey 904. In an exemplary embodiment, the details obtained from the static survey 902 and the dynamic survey 904 are analyzed to obtain filtered data for generating reports. For exemplary purposes as shown in FIG. 9, the static survey provides personal details of the audience such as Logged in with, Gender, Relationship and Education and dynamic survey analysis provides specified information as required by the moderator such as ‘Are you a certified meeting Professional’, ‘Are you studying for the CMP exam’ etc.

The moderator filters the audience from analyzing the data from the static survey and the dynamic survey, such as Number of People who logged in with Email are Male and also A certified meeting professional. Similarly, other details may also be analyzed from the data available to filter the audience. Thus, the filtered data assist in generating reports with the specific data as required by the moderator. The statistical data obtained after interpretation of the static data and dynamic data is available for analytical interpretation as required by various government and other departments.

FIG. 10 is a screenshot showing, by way of an example, a Web page presenting the report 1000 of answers provided by the audience. The report 1000 is created on the questions asked by the audience during the polling session by the moderator from the database. In another embodiment of the present invention, the report 100 may also be created on the specific population. In an exemplary embodiment FIG. 10 shows, responses 1002 of audience on each question 1004. The report 1000 further provides graphical presentation 1006 of responses of audience for each question.

However, it will be readily apparent to those skilled in the art that various other information related to the interpret data from static survey and dynamic survey and responses in polling session depending upon the requirement of the moderator. The report 1000 may be extracted from the database in excel format, word format, pdf format and the likes. In another embodiment of the present invention, the reports are generated in anonymous format for delivering percentage of correct answers. Further, the reports are generated in exam format for classroom examination use.

FIG. 11 is a screenshot showing, by way of an example, a Web page of audience communication device 500 showing scanning of QR code 1102. In another preferred embodiment of the present invention, the audience is allowed to participate in the polling session only after registering the audience computing device. For exemplary purposes as shown in FIG. 11, the audience computing device 500 is registered by scanning the QR code 1102. The QR code 1102 is shown on the display screen of the prompter screen. However, it will be readily apparent to those skilled in the art that the QR code may be shown to the audience through various other means without deviating from the scope of the invention.

FIG. 12 is a screenshot showing, by way of an example, a Web page for showing manipulation of session moderator module 400. The manipulation of session moderator module 400 includes but not limited to Add Questions 1202 for addition of questions in the polling session that are required to be asked from the audience, Refresh View 1204 for refreshing and reloading the list of questions and Delete option 1206 for deleting each question that the moderator wish to delete from the list of the questions created via the session moderator module 400.

In another embodiment of the present invention, with the reference from FIG. 4, the Question Type Module 408 selects the type of question to be asked from the audience. The Question Type Module 408 includes various options to select the type of question that moderator wish to add from the Question Type drop down list. The options include True False, TF-With Answer, Multiple and Muti with Answer.

Further, the Number of Answer Module 410 provides the number of answers for the question. For exemplary purposes, answer options for True False type question is two i.e. A and B. The Time Duration Module 412 allows the moderator to set a time for allowing the audience to answer each question displayed during the polling session. For exemplary purposes, the time duration is ‘10 seconds’. However, it will be readily apparent to those skilled in the art various other options for the Question Type Module 408, the Number of Answer Module 410 and the Time Duration Module 412 may also be envisioned without deviating from the scope of the invention.

FIG. 13 is a screenshot showing, by way of an example, a Web page of audience computing device to show the voting status of each question asked from the audience. Herein for exemplary purposes, voting refers to the responding of the answers by the audience. When the audience responds to each question, a voting status 1302 is displayed on the audience computing device. As shown in FIG. 13a in an exemplary embodiment, For Question 1 the audience has voted correctly and thus receives a message of Voting Received 1302 on the audience computing device.

Further as shown in FIG. 13b in an exemplary embodiment, the audience responded after the time duration given to them and thus receives a message of Voting Locked 1304 on the audience computing device. Voting Locked 1304 indicates that the audience responded after the time duration given to them. Also in case the audience have answered a question and moved to the next question, but the moderator is still on the previous question. Then also your question will be locked and a voting locked 1304 is displayed. Voting Received 1306 indicates that audience has responded to the question in time.

The present invention offers various advantages such as able to differentiate between populations using specific variables giving the moderator the ability to compartmentalize collected sample data. The statistical data gathered is available for analytical interpretation. Further, the present invention generate reports in filtered format allowing users to choose the criteria for which to generate reports on a specific sample. Thus, the present invention is useful for various government departments engaged in collection samples.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

1. A method for interpreting data of audience from a polling session managed by a moderator, said method comprising the steps of:
registering on a database for creating the polling session by the moderator through moderator computing device;
creating questions and their answers by the moderator to be asked from the audience in a session moderator module;
presenting the questions prepared by the moderator to the audience;
registering the audience computing device for the polling session and for generating static data related to the audience;
conducting a session moderator survey of the registered audience for generating a dynamic data related to the audience;
answering by the audience from their computing device to the questions displayed to the audience by the moderator in real time;
interpreting the static data with the dynamic data of session moderator survey to filter the audience participating in the polling session for generating reports; and
downloading the reports from the database of the answers provided by the audience to the questions asked in the polling session by the moderator.

2. The method according to claim 1 further comprising the step of scanning a code by the audience from their computing device for participating in the polling session.

3. The method according to claim 1 further comprising the step of manipulating the questions created in the session moderator module.

4. The method according to claim 1 further comprising the step of setting a time for allowing the audience to answer each question displayed during the polling session.

5. The method according to claim 1 further comprising the step of setting the type of each question to be asked from the audience through a question type module.

6. The method according to claim 1 further comprising the step of setting the number of answers for each question to be asked from the audience through an answer module.

7. The method according to claim 1 further comprising the step of sending a notification on the audience computing device after each question about the status of their voting.

8. A system for interpreting data of audience from a polling session managed by a moderator over a server, said system comprising:
a database for storing data related to audience, moderator and polling session; and
a processor coupled to said database, said processor is configured to:
register on a database for creating the polling session by the moderator;
create questions and their answers by the moderator to be asked from the audience in a session moderator module;
present the questions prepared by the moderator to the audience;
register the audience computing device for the polling session and for generating static data related to the audience;
conduct a session moderator survey of the registered audience for generating a dynamic data related to the audience;
answer by the audience from their computing device to the questions displayed to the audience by the moderator in real time;
interpret the static data with the dynamic data of session moderator survey to filter the audience participating in the polling session for generating reports; and
download the reports on the answers provided by the audience to the questions asked in the polling session by the moderator from the database.

9. The system according to claim 8 wherein said processor is further configured to scan a code by the audience from their computing device for participating in the polling session.

10. The system according to claim 8 wherein said processor is further configured to manipulate the questions created in the session moderator module.

11. The system according to claim 8 wherein said processor is further configured to set a time for allowing the audience to answer each question displayed during the polling session.

12. The system according to claim 8 wherein said processor is further configured to set the type of each question to be asked from the audience through a question type module.

13. The system according to claim 8 wherein said processor is further configured to set the number of answers for each question to be asked from the audience through a answer module.

14. The system according to claim 8 wherein said processor is further configured to send a notification on the audience computing device after each question about the status of their voting.

15. A non-transitory computer readable storage medium having instructions for a database stored thereon that, when executed by a processing device, cause the processing device to perform a method for interpreting data of audience from a polling session managed by a moderator over a communication network comprising the steps of:
registering on a database for creating the polling session by the moderator;
creating questions and their answers by the moderator to be asked from the audience in a session moderator module;
presenting the questions prepared by the moderator to the audience;
registering the audience computing device for the polling session and for generating static data related to the audience;
conducting a session moderator survey of the registered audience for generating a dynamic data related to the audience;
answering by the audience from their computing device to the questions displayed to the audience by the moderator in real time;
interpreting the static data with the dynamic data of session moderator survey to filter the audience participating in the polling session for generating reports; and
downloading the reports of the answers provided by the audience to the questions asked in the polling session by the moderator from the database.

16. The non-transitory computer readable storage medium of claim 15 wherein the method further comprising the step of scanning a code by the audience from their computing device for participating in the polling session.

17. The non-transitory computer readable storage medium of claim 15 wherein the method further comprising the step of manipulating the questions created in the session moderator module.

18. The non-transitory computer readable storage medium of claim 15 wherein the method further comprising the step of setting a time for allowing the audience to answer each question displayed during the polling session.

19. The non-transitory computer readable storage medium of claim 15 wherein the method further comprising the step of setting the type of each question to be asked from the audience through a question type module.

20. The non-transitory computer readable storage medium of claim 15 wherein the method further comprising the step of setting the number of answers for each question to be asked from the audience through an answer module.
